(19) United States
(12) Patent Application Publication
(10) Pub. No.: US 2008/0173523 A1
(43) Pub. Date: Jul. 24, 2008

(54) Belt lock for a safety belt

(76) Inventors: Joachim Bahr, Oldenburg (DE); Bruno Stenzel, Hatten (DE); Carsten Weyand, Edewecht (DE); Andreas Falk, Oldenburg (DE)

Correspondence Address: COLLARD & ROE, P.C., 1077 NORTHERN BOULEVARD, ROSLYN, NY, 11576, US

(21) Appl. No.: 12/009,998

(22) Filed: Jan. 23, 2008

(30) Foreign Application Priority Data
Jan. 24, 2007 (DE) DE 102007003567.7

(51) Int. Cl. B60R 22/48

(52) U.S. Cl. 200/61.58 B

(57) ABSTRACT

In a device for the accommodation and retention of a lock part, in particular a belt lock of a safety belt, with at least one restraint device for the lock part, which has at least one movable latching element that can be brought into a retentive active connection with the lock part, and with an interrogation device having at least one electrical switching element to record the closing position of the restraint device, the electrical switching element is directly assigned to the latching element. The switching element has an actuating element projecting into the movement space of the latching element and is designed as a button that can be actuated by the latching element.

The invention relates to a device for the accommodation and retention of a lock part, in particular a belt lock of a safety belt, with at least one restraint device at least partly enclosing the lock part, which has at least one movable latching element that can be brought into a retentive active connection with the lock part, and an interrogation device having at least one electrical switching element to record the closed position of the restraint device.

There are devices of known art, for example belt locks for a means of transport fitted with at least one safety belt, in particular a motor vehicle, which are part of a restraint device system, which in turn are used to secure persons in a large number of means of transport. Devices of known art have a restraint device for a lock part to be accommodated and retained in the device. The restraint device is equipped with a movable latching element, which normally latches automatically when the lock part has been introduced into the restraint device. For this purpose the latching element engages in a cut-out or an aperture of the lock part. The form fit connection thereby generated always guarantees an optimal retention of the lock part in the restraint device. Moreover the device has an interrogation device to record the closed position of the restraint device, in order to detect, if necessary, a lock part incorrectly accommodated in the device, and to output information in the form of a visual or an acoustic signal. For this purpose the interrogation device has at least one electrical switching element, which according to the closed position of the restraint device is brought into a pre-determined switch position and generates a correspondingly assigned signal.

In the case of devices of a genus of known art additional functional parts, mechanically coupled with the switching element, are normally used to effect an actuation of the switching element. The use of a mechanism, which can, for example, be actuated via the insertion of the lock part into the restraint device, and which in turn acts on the switching element of the interrogation device mechanically, always results in a complex design for the embodiment of the device. Moreover more defects can on occasion arise in the extra functional parts of such a mechanism used in the device, resulting in a reduced operational reliability for the interrogation device.

The object of the invention is to improve a device of the genus previously described to the effect that simplified and at the same time cost-effective manufacture is possible.

The object is achieved according to the invention by means of a device with the features of Claim 1. Advantageous further developments and embodiments of the invention are specified in Claims 2 to 12.

In a device of the genus previously described provision is made according to the invention that the electrical switching element is assigned directly to the latching element, wherein the switching element has an actuating element projecting into the movement space of the latching element.

With the aid of a switching element, projecting, for example, into the swivelling path of a latching element, an advantageously simple actuation of an interrogation device to record the closed position of the restraint device is provided. The direct actuation of the switching element by the latching element without any interconnection of other functional parts moreover ensures a simple design for the embodiment of the device. The avoidance of the use of a mechanism transferring particular movements and forces, alongside a simplified manufacture of such a device designed according to the invention, thus guarantees at the same time increased operational reliability and/or operationally reliable long-term functionality.

According to an advantageous further development of the invention, provision is made that the switching element is a button that can be actuated by means of the latching element. By the use of a button as a switching element an advantageous option is provided for the closing or interruption of current circuits, in particular a current circuit of the interrogation device. Moreover the button has the advantageous property that after its actuation it returns automatically into a predetermined quiescent position. This assumes that a force acting in an opposite manner to the latching movement of the latching element acts on the actuating element, provided, for example, by a spring acting permanently on the actuating element. Needless to say, instead of a button it is also possible to use other electromechanical components, such as a switch, for example.

The switching element is preferably designed as a closer, that connects together at least two closing contacts in an electrically conducting manner. By means of a switching element designed as a closer it is possible to establish an electrically conducting connection, in particular in a current circuit of the interrogation device, and in this regard a voltage signal of predetermined level required for the interrogation function can be connected through the interrogation device in an advantageously simple manner. Needless to say it is also conceivable to design the switching element as an opener to implement a switching function that then interrupts an electrically conducting connection between the closing contacts of a current circuit of the interrogation device.

The switching element has at least one base accommodating the closing contacts, which with advantage serves as a base for the design of the switching element and also takes on the function of an insulator between each of the closing contacts fitted on the base. In order to be able to ensure an insulation action for the base, a material, in particular a non-metal, is used for the design of the base, which advantageously prevents any possible flow of current.

The base of the switching element is arranged on at least one shell-type cover part of a housing enclosing the restraint device almost completely. The arrangement of the switching element on a cover part designed as a lock shell of the housing designed in at least two parts enables an advantageous arrangement of the switching element in the movement space of the latching element designed as a swivelling region. The base of the switching element can have a plurality of seatings designed as apertures, via which the switching element is retained on the inner side of the cover part by means of positioning elements designed as pegs. It is likewise conceivable to connect the base of the switching element with the inner side of the cover part in a material fit using a jointing medium, such as an adhesive, for example.

According to a further development of the invention provision is made that the base has at least one overlapping edge screening the closing contacts. By means of the overlapping edge, in the event of penetration of a fluid medium, for example, into the device according to the invention, any direct contact between the closing contacts of the switching element with the medium should be prevented in an advantageous manner. The overlapping edge ensures in this event a systematic removal of the medium, without causing any unintentional electrically conducting connection between the closing contacts arranged on the base.

The actuating element is arranged on the base of the switching element such that the contact surfaces of a connecting contact assigned to the actuating element, which can be brought into contact with the closing contacts, are moveably guided along a respective contact region. In the actuation procedure the contact surfaces of the connecting contact, immediately after touching down onto the closing contacts arranged on the base, are moved over a section of a respective contact region of the closing contacts. By means of the sliding movement and/or abrading function of the connecting contact on the closing contacts an over-travel of the actuating element and thus of the connecting contact is possible. By means of the over-travel any possible production tolerances can be compensated for in an advantageous manner, guaranteeing an optimal contact between the closing contacts and the connecting contact. Moreover any contaminants or oxidation layers located on the contact regions are removed by the sliding movement of the surfaces relative to one another.

On the actuating element is arranged at least one restoring aid, which generates an additional force acting on the actuating element in order to move the latter back into its quiescent position. Here the restoring aid has a supporting function to at least one elastically designed connecting element that connects the base with the actuating element of the switching element. In this manner a reliable lift-off of the connecting contact from the closing contacts of the switching element is always guaranteed when unlatching of the lock part has occurred in the device according to the invention.

Each restoring aid has at least one supporting part sliding on predetermined surfaces, whereby in addition to an improved restoring function at the same time the latching force acting on the actuating element, as a result of the latching element engaging with the latter, is optimally accommodated. Any excessive material loading on the elastically designed connecting elements can thus be prevented. The free ends of each restoring aid are preferably designed as a contact face supported on a predetermined surface, in order at the same time to guarantee an optimal actuation of the switching element. The free end of each restoring aid can be supported on a contact surface of a respective closing contact of the switching element.

According to another further development of the invention provision is made that at least the connecting contact is fitted with at least one punctiform design of contact surface for each closing contact. The embodiment of the contact surfaces, as a contact spike or a contact bead, for example, in conjunction with the sliding movement of the connecting contact on the closing contacts effects a further improved electrically conducting connection between the contacts coming to lie on top of one another in each case. In addition to the connecting contact the contact regions of the closing contacts can also, for example, be provided with a contact bead, which can be introduced into correspondingly suitable contact materials, for example, by means of a stamping method.

Independent protection is requested for an interrogation device, which can be used in conjunction with a device for the accommodation and retention of a lock part according to one of the Claims 1 to 11. Interrogation devices according to the invention can in particular be offered as retrofit sets for devices of known art in order to guarantee the ongoing use of devices already in service. The embodiment of the interrogation device according to the invention moreover ensures a universal applicability on the devices of known art, in particular those designed as a belt lock.

An example of embodiment of the invention, from which further inventive features ensue, is represented in the drawing. In the figures:

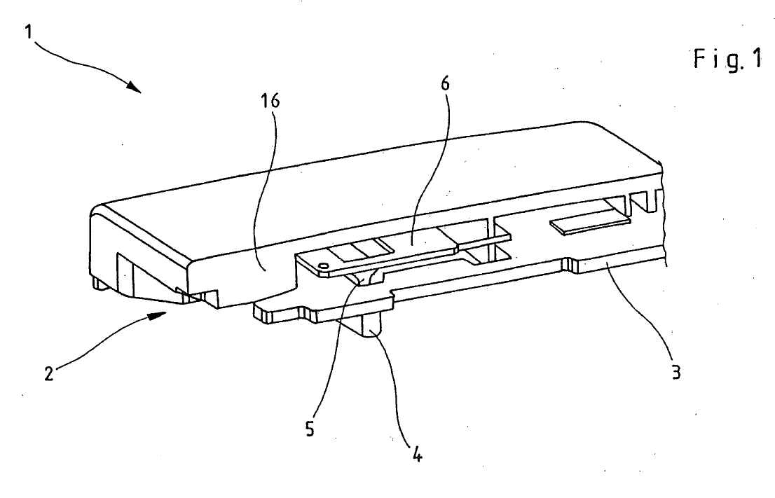

FIG. 1: shows a perspective scrap view of a device for the accommodation and retention of a lock part;

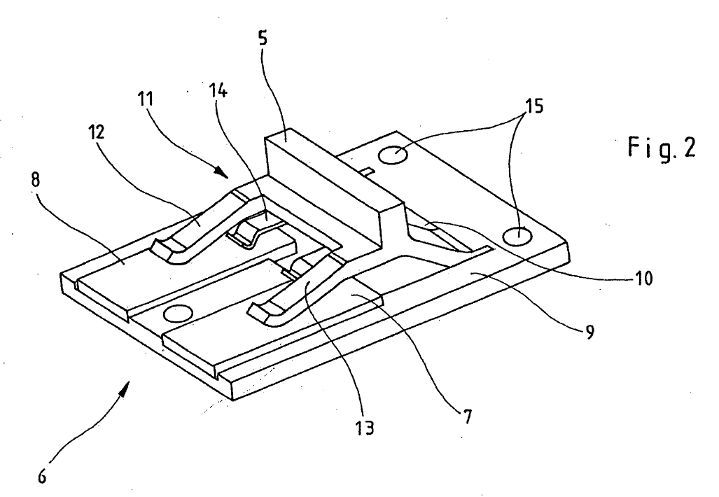

FIG. 2: shows a first example of embodiment of a switching element according to FIG. 1, and

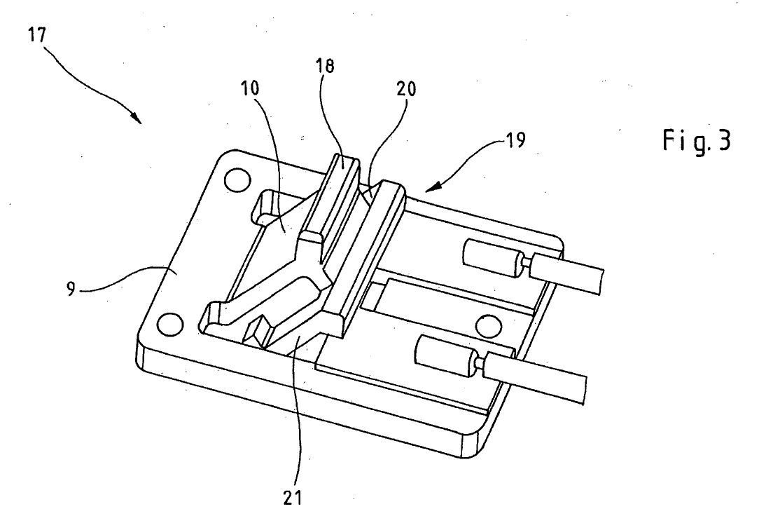

FIG. 3: shows a further example of embodiment of a switching element.

FIG. 1 shows a part view of a device 1 for the accommodation and retention of a lock part, not represented, wherein the arrow 2 indicates the direction of insertion of the lock part. The device 1 has a restraint device 3 for the insertable lock part, which is equipped with a movable latching element 4 that can be brought into a retentive active connection with the lock part. Immediately after the insertion of the lock part into the device 1 the latching element 4 executes a swivelling movement, which leads to the lock part being latched in the restraint device 3, and at the same time an actuating element 5 of a switching element 6. projecting into the movement space of the latching element 4. is actuated. The switching element 6 is part of an interrogation device to record the closed position of the restraint device 3, in order to be able to detect the retention of the lock part in the device 1.

In FIG. 2 is represented a first example of embodiment of the switching element 6, which has two closing contacts 7, 8. The closing contacts 7, 8 are accommodated by a base 9 designed as a carrier plate, which at the same time has the function of an insulator and thus prevents the direct flow of current between the closing contacts 7, 8. The actuating element 5 is designed in one piece with the base 9, which via a correspondingly elastic connecting element 10 is held in a sprung manner on the base 9. Moreover the actuating element 5 has a restoring aid 11, which has two supporting parts 12, 13 sliding on the contact regions of the closing contacts 7, 8. The supporting parts 12, 13, ensure, in particular after the actuating element 5 has been offloaded by the latching element 4, a reliable lift-off from the closing contacts 7, 8 of a connecting contact 14 assigned to the actuating element 5. Moreover the switching element 6 has in the base 9 a plurality of seatings 15, by means of which the switching element 6 is retained on a cover part 16 (FIG. 1), designed as a lock shell, of a housing almost completely enclosing the restraint device 3.

In FIG. 3 is represented a further example of embodiment of a switching element 17, on whose actuating element 18 a restoring aid 19 is arranged, which has two supporting parts 20, 21 sliding directly on the inner side of the cover part 16 designed as a lock shell. Furthermore the same elements are provided with the same reference numbers.

1. A device for the accommodation and retention of a lock part, in particular a belt lock of a safety belt, with at least one restraint device for the lock part, which has at least one movable latching element that can be brought into a retentive active connection with the lock part, and with an interrogation device having at least one electrical switching element to record the closed position of the restraint device,
wherein the electrical switching element (6, 17) is directly assigned to the latching element (4), wherein the switching element (6, 17) has an actuating element (5, 18) projecting into the movement space of the latching element (4).

2. The device according to claim 1, wherein the switching element (6, 17) is a button that can be actuated by means of the latching element (4).

3. The device according to claim 1, wherein the switching element (6, 17) is designed as a closer, which connects at least two closing contacts (7, 8) with one another in an electrically conducting manner.

4. The device according to claim 1, wherein the switching element is an opener separating the electrical connection between the closing contacts.

5. The device according to claim 1, wherein the switching element (6, 17) has at least one base (9) accommodating the closing contacts (7, 8).

6. The device according to claim 5, wherein the base (9) is arranged on at least one shell-type cover part (16) of a housing almost completely enclosing the restraint device (3).

7. The device according to claim 5, wherein the base (9) has an overlapping edge screening at least the closing contacts (7, 8).

8. The device according to claim 1, wherein the actuating element (5, 18) on the base (9) of the switching element (6, 17) is arranged such that the contact surfaces of a connecting contact (14) assigned to the actuating element (5, 18), which can be brought into contact with the closing contacts (7, 8), are moveably guided along a respective contact region.

9. The device according to claim 1, wherein at least one restoring aid (11, 19) is arranged on the actuating element (5, 18).

10. The device according to claim 9, wherein each restoring aid (11, 19) has at least one supporting part (12, 13, 20, 21) sliding along predetermined surfaces.

11. The device according to claim 8, wherein at least the connecting contact (14) is equipped with at least one punctiform contact surface designed as a bead or a contact pill for each closing contact (7, 8).

12. An interrogation device for a device (1) for the accommodation and retention of a lock part according to claim 1.
